(19) United States
(12) Patent Application Publication
(10) Pub. No.: US 2019/0058979 A1
(43) Pub. Date: Feb. 21, 2019

(54) Remote diagnostic system

(71) Applicant: Envolve Intellectual Property LLC, Evansville, IN (US)

(72) Inventors: Michael E. Stagg, Evansville, IN (US); Jonathan Weber, Evansville, IN (US)

(73) Assignee: Envolve Intellectual Property LLC, Evansville, IN (US)

(21) Appl. No.: 15/998,419

(22) Filed: Aug. 15, 2018

Related U.S. Application Data
(60) Provisional application No. 62/545,671, filed on Aug. 15, 2017.

(51) Int. Cl. H04W 4/38; H04W 4/029

(52) U.S. Cl. CPC H04W 4/38; H04W 84/18; H04W 4/029

(57) ABSTRACT

Systems and methods for remotely diagnosing sensor environments are provided. In one embodiment, a remote diagnostic system comprises a backend cloud server configured to analyze at least one set of sensor data received from at least one remote system. The backend cloud server may be configured to receive the at least one set of sensor data via a cellular network. In another embodiment, a command module of a remote diagnostic system comprises at least one sensor port. Each sensor port is configured for electrical connection with a sensor chip that measures a parameter or condition and may be configured to receive sensor data obtained by the respective sensor chip. The command module also includes a cellular communication device configured to transmit the sensor data via a cellular network to a backend cloud server for diagnosing characteristics of the sensor data.

### CROSS-REFERENCE TO RELATED APPLICATIONS

This application claims priority to Provisional Application No. 62/545,671, filed Aug. 15, 2017.

### BACKGROUND

A large number of various types of sensors are currently being used to measure or detect different parameters or conditions. Typical sensors will usually provide output signals that can be monitored by users in the vicinity of the sensors. However, unless a user is continuously monitoring the output from a sensor, critical events related to a sensed system may go unnoticed.

As an example, temperature sensors may be used within transport vehicles (e.g., a vehicle for transporting human organs) for monitoring the temperature of refrigeration systems, medical coolers, etc. However, if a problem occurs with the refrigeration system or medical cooler, a sensed temperature drop may not be noticed by a person who could then act upon this important information.

Therefore, a need exists for sensors to be used in systems where there is additional diagnostics and monitoring of the sensors in order to allow control processes to be performed, if needed, especially when the sensors measure parameters or conditions that are considered to be outside of acceptable limits.

### SUMMARY

The present disclosure defines systems and methods for remotely diagnosing sensor data. In one implementation, a remote diagnostic system comprising a backend cloud server configured to analyze at least one set of sensor data received from at least one remote system. The backend cloud server may be configured to receive the at least one set of sensor data via a cellular network.

According to another implementation, a command module of a remote diagnostic system is provided. The command module comprises at least one sensor port and a cellular communication device. Each sensor port is configured for electrical connection with a sensor chip that measures a parameter or condition and is configured to receive sensor data obtained by the respective sensor chip. The cellular communication device is configured to transmit the sensor data via a cellular network to a backend cloud server for diagnosing characteristics of the sensor data.

### BRIEF DESCRIPTION OF THE DRAWINGS

FIG. 1 is a block diagram illustrating a remote diagnostic system, according to some embodiments.

FIG. 2 is a block diagram illustrating the backend cloud server shown in FIG. 1, according to some embodiments.

FIG. 3 is a block diagram illustrating the command module shown in FIG. 1, according to some embodiments.

FIG. 4 is a schematic diagram illustrating a sensor port that may be used with the command module of FIG. 3, according to some embodiments.

### DETAILED DESCRIPTION OF EMBODIMENTS

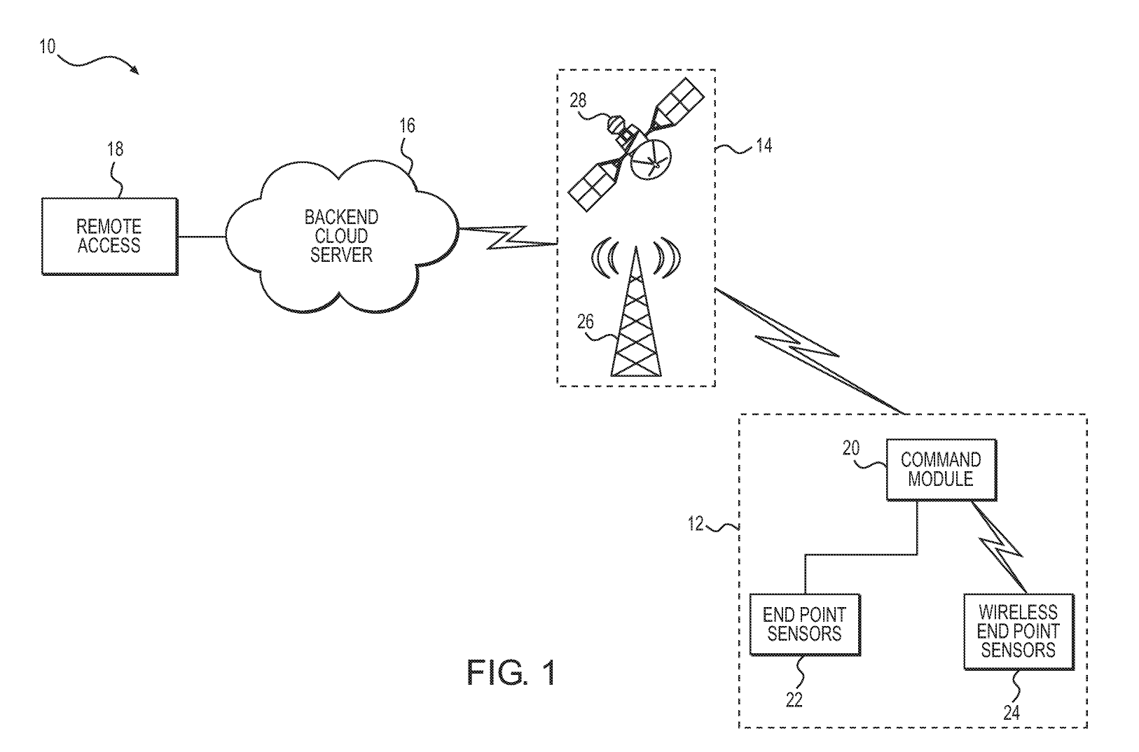

FIG. 1 is a block diagram showing an embodiment of a remote diagnostic system 10. According to this embodiment, the remote diagnostic system 10 generally includes a local network 12, a cellular network 14, a backend cloud server 16, and a remote access 18. In some embodiments, multiple local networks 12 may be configured in the remote diagnostic system 10, whereby the backend cloud server 16 can monitor and diagnose sensor data from each of the local networks 12. Thus, one local network 12 may be installed in an environment for sensing one particular system, while another local network 12 may be installed in another environment for sensing a completely different system. Also, the types of sensors and parameters being sensed in each specific local network 12 may be different.

The local network 12 represents an environment where sensing will take place. In a sense, the local network 12 may be considered as a “remote network” or “remote system” from the perspective of the backend cloud server 16. The sensing environment of the local network 12 may be stationary or mobile, depending on the application. One example of a mobile sensing environment may include sensing parameters on a moving vehicle, such as the sensing of temperature in a refrigeration vehicle. On the other hand, an example of a stationary sensing environment may include the sensing of a fuel level of a stationary propane gas tank.

The local network 12 includes a command module 20 and any number of wired end point sensors 22 and/or wireless end point sensors 24. The cellular network 14 may include any number of cellular towers 26 and/or cellular satellites 28 for communicating cellular signals. The command module 20 may include communication equipment for communicating cellular signals to the cellular network 14, which in turn communicates the signals to the backend cloud server 16. The signals communicated via the cellular network 14, according to the present disclosure, may include at least sensor data that is obtained by the end point sensors 22, 24. Thus, the sensor data obtained in each local network 12 can be communicated remotely to the backend cloud server 16.

The backend cloud server 16 may be configured to analyze the sensor data and derive useful information that can be handled in different ways, depending on the application and how each individual sensing system (i.e., each local network 12) is configured. In some embodiments, sensor information may be accessed by the remote access 18.

In some embodiments of the present application, the remote diagnostic system 10 may be viewed as a turnkey solution for collecting, storing, and accessing a variety of data types. Since each local network 12 may represent any type of sensing environment, specific end point sensors 22, 24 may be installed in the local network 12 to sense one or more specific parameters or conditions. Thus, any types of sensors can be installed into any local network 12 as may be needed in the particular sensing environment.

A user may be able to utilize any available end point sensor 22, 24 by simply installing the sensor into the local network 12, which may involve plugging a sensor chip of a wired end point sensor 22 into a sensor port of the command module 20. The command module 20 may have sensor ports that allow for a variety of “plug and play” sensor types. Also, one or more wireless end point sensor 24 may be installed at locations in wireless range of the command module 20.

The local network 12 in some embodiments is a proprietary wireless network, which does not interfere or require any other network access for operation. Once sensor data is sent from the sensors 22, 24 to the command module 20, the sensor data may be processed and sent via an integrated cellular modem of the command module 20 to the remote server (e.g., the backend cloud server 16) where the sensor data may be stored and/or diagnosed.

The backend cloud server 16 may include software, which, of course, will be remote from the original source of the sensor data (at the local network 12). The software may be configured to enable the backend cloud server 16 to analyze the data. Then, based on the results of the analysis, the backend cloud server 16 may send warnings or alerts to notify authorized personnel of operational conditions or recommended repairs and maintenance. In some embodiments, the criteria for analyzing the sensor data may be configured by a user, such as by using the remote access 18, which may be a computer terminal that accesses sensor data from the backend cloud server 16 via the Internet.

Therefore, according to one embodiment, the present disclosure teaches the remote diagnostic system 10 comprising the backend cloud server 16 configured to analyze at least one set of sensor data received from at least one remote system (e.g., local network 12). The backend cloud server 16 may be configured to receive the at least one set of sensor data via the cellular network 14.

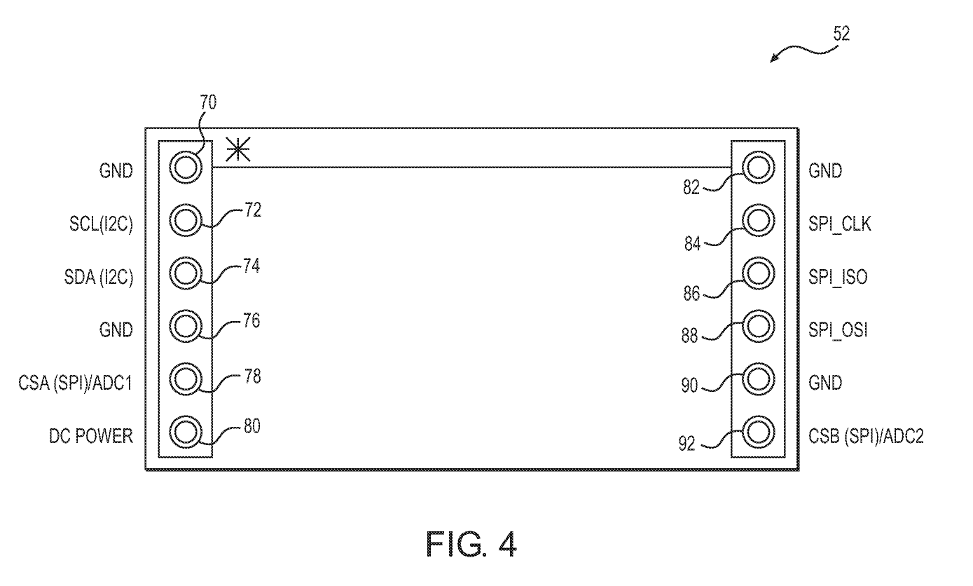

The remote diagnostic system 10 may further be configured such that each remote system 12 comprises a command module (e.g., command module 20) and one or more end point sensors 22, 24 for obtaining a set of sensor data. The command module 20 may be configured to transmit the set of sensor data via the cellular network 14 to the backend cloud server 16. At least one of the end point sensors 22, 24 may include a chip configuration for connection to a sensor port (as described with respect to FIG. 4) of the command module 20.

The backend cloud server 16 may be configured to determine an alert condition when a first set of sensor data from a first remote system includes parameters outside an acceptable range. The backend cloud server 16 may include a controller for controlling the first remote system when the alert condition is determined. Also, the backend cloud server 16 may be configured to enable one or more remote access terminals 18 to access sensor data related to one of the at least one remote system. Using the remote access 18, communication warnings and alerts can be monitored via Internet connectivity (mobile or fixed).

The remote diagnostic system 10 may be used in a wide range of applications. For example, the remote diagnostic system 10 may be used in critical system monitoring, HVAC control systems, medical cooler and transport, refrigerated transport, driver assist, vehicle life assist, medical wash systems, oil and gas maintenance, controlled substance tracking, among others.

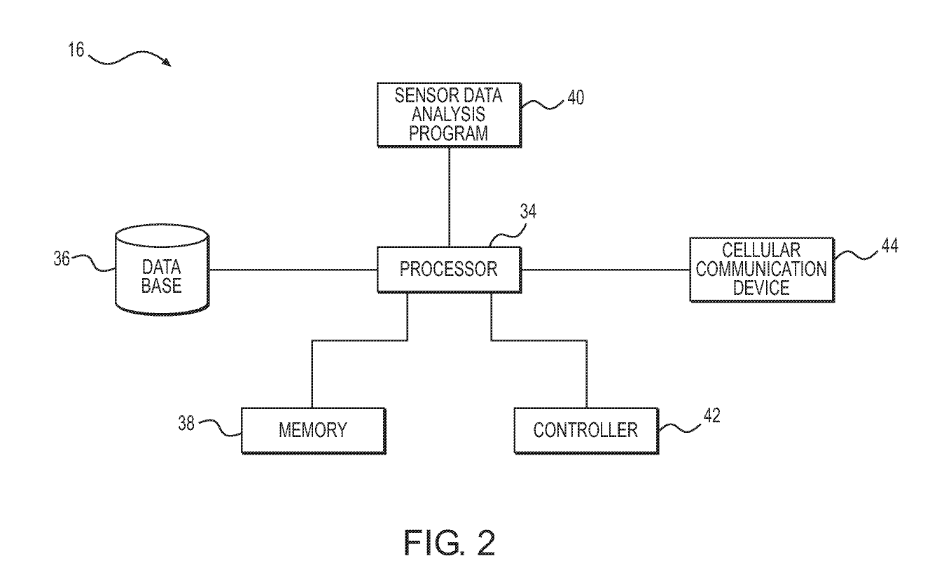

FIG. 2 is a block diagram showing an embodiment of the backend cloud server 16 shown in FIG. 1. In this embodiment, the backend cloud server 16 may include at least a processor 34, one or more databases 36, memory 38, a sensor data analysis program 40, a controller 42, and a cellular communication device 44. The cellular communication device 44 is configured to receive signals representing sensor data from the cellular towers 26 and/or cellular satellites 28 of the cellular network 14.

The received signals are processed by the processor 34 to extract the sensor data. The sensor data may be stored in memory 38 or cache for short term processing and/or may be stored in the database 36. The processor 34 may utilize the sensor data analysis program 40, which may be configured in hardware, firmware, and/or software. The sensor data analysis program 40 allows the processor 34 to analyze the sensor data to determine various characteristics about the data. In some situations, the controller 42 may be used to control output devices for providing alarms, alerts, etc., to inform a person or machine that one or more actions need to be taken in response to parameters or conditions of the sensed data that warrants special attention.

In addition to analyzing collected data, the backend cloud server 16 can be used to look at historical data stored in the database 36 and present likely causes of failures to a technician related to the local network 12 in which the sensor data was taken. This is especially useful to prevent multiple service calls for the same issue and to reduce the time needed to service the equipment.

Thus, the backend cloud server 16 collects the sensor data and can examine and compare the data with preset limits in order to determine any points of discrepancy between what is analyzed and what the values or parameters should be. The backend cloud server 16 may utilize the sensor data analysis program 40 to collate the sensor data in this way to thereby diagnose if the parameters are outside acceptable limits or if a condition is detected that needs attention.

Thus, this process can be done automatically without human input. Then, when any alert condition arises, the backend cloud server 16 can utilize the controller 42 to controller certain equipment as needed to make adjustments to correct any discrepancies in the local network 12 or alert an authorized individual of the situation. In some embodiments, the controller 42 of the backend cloud server 16 may be configured as a system of controllers for controlling a plurality of different systems.

The backend cloud server 16 can log the sensor data from the various local networks 12 into the database 36, which may be configured as cloud storage for remote access. Alarms can be configured for out of boundary conditions as well as operational trends and diagnostics. The backend cloud server 16 monitors the equipment for conditions that are out of specification but also recognizes trends in data to facilitate maintenance or early identification of performance issues.

The backend cloud server 16 may be configured to operate 24 hours a day to allow continuous monitoring of sensor data. Real time access to the sensors can allow the backend cloud server 16 to be up-to-date at all times. In some implementations, status alerts or push alerts may be provided via mobile communication and/or via email, depending on how each local network 12 is configured.

In some embodiments, the sensor data analysis program 40, in part or in whole, may also be installed in one or more of the individual local networks 12. Thus, the program 40 may also allow for access of the local equipment on site through near field communication (NFC) or other wireless communication. Data can then be retrieved locally or downloaded remotely to pinpoint component failure. The sensor data analysis program 40 may be a diagnostic application that accesses the appropriate sensor data from the database 36 and helps a technician or other user associated with the local network 12 to perform diagnostic processes based on the archived data.

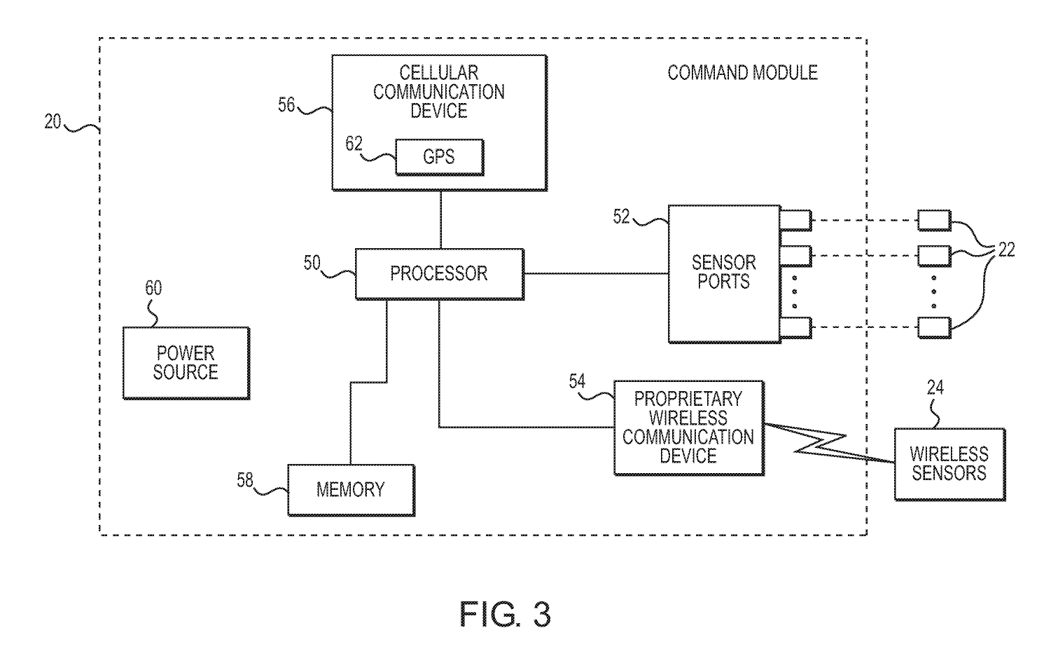

FIG. 3 is a block diagram showing an embodiment of the command module 20 of the local network 12. According to this embodiment, the command module 20 includes a processor 50, one or more sensor ports 52, a proprietary wireless communication device 54, a cellular communication device 56, memory 58, and a power source 60. In some embodiments, the cellular communication device 56 may contain a global positioning system (GPS) device 62 for determining the location of the command module 20, which may be useful for determining a location when parameters are sensed, particularly in a mobile sensing environment.

The components of the command module 20 (i.e., processor 50, sensor ports 52, proprietary wireless communication device 54, cellular communication device 56, memory 58, and power source 60) may be configured on a printed circuit board (PCB). The power source 60 may be configured to provide power to the other components of the command module 20 and may comprise battery power sources, solar power sources, etc.

As described above with respect to FIG. 1, the command module 20 is configured in electrical communication with wired end point sensors 22 and wireless end point sensors 24. The sensors 22, 24 may include any suitable type of sensors for measuring or detecting any type of characteristic, parameter, condition, etc. The sensors 22, 24 may be configured as stand-alone sensors, sensor chips, remote switches, etc. As shown in FIG. 3, the wired sensors 22 may be physically and electrically connected to the sensor ports 52, such as by plugging the sensors 22 into the sensor ports 52. On the other hand, the wireless sensors 24 are configured to communicate with the proprietary wireless communication device 54 using any suitable short range wireless communication protocol, such as Wi-Fi, Bluetooth, NFC, etc.

In one embodiment, one or more wired end point sensors 22 can be plugged into the sensor ports 52. According to some embodiments, both the sensor ports 52 and the sensors 22 may include a proprietary pin layout and schematic. As such, when a particular type of sensor is needed in the local network 12, the specific sensor 22 can be plugged into the sensor port 52. The sensor 22 can then be powered by the power source 58 and the sensor data from the sensor 22 can be processed by the processor 50 and stored temporarily in memory 58. Also, the processor 50 may be configured to send sensor data to the cellular communication device 56 for transmission to the backend cloud server 16 on a periodic basis or when the sensor data is determined to include parameters that lie outside of acceptable limits.

One or more wireless end point sensors 24 may additionally or alternatively be employed. As such, the wireless end point sensors 24 may be installed at a location near the command module 20, or at least near enough where the wireless end point sensors 24 can communicate with the proprietary wireless communication device 54 over a short range using any suitable short range communication protocol. In some embodiments, the proprietary wireless communication device 54 may be configured to ping the wireless sensors 24 on a regular basis to obtain sensor data from the sensors 24 and/or the sensors 24 may be configured to transmit sensor data according to a periodic schedule.

The proprietary nature of the communication between the proprietary wireless communication device 54 and the wireless sensors 24 allows the local network 12 to be simplified. For instance, site installation in the local network 12 and the wireless connectivity simplifies the communication between the local network 12 and the backend cloud server 16. This allows the sensing environment of the local network 12 to be installed in any areas, even without immediate Wi-Fi or other network access.

Since the wireless sensors 24 will not normally be powered by the power source 60, the wireless sensors 24 may include battery power components, solar power components, etc. for powering the sensor and/or recharging a portable power source associated with the sensor.

The command module 20 handles site data processing and transmission through the integrated cellular communication device 56 (e.g., modem) or through Wi-Fi or Bluetooth devices when used with a separate device for communicating with the backend cloud server 16. Additionally, the command module 20 may have multi-use, customized sensor ports that can accept multiple sensor types. The power source 60 may include a power supply that can operate from a battery, DC voltage, or a solar charger. In addition to the direct measurement of data through the sensor ports 52, the proprietary wireless communication device 54 allows for a private Wi-Fi network to be established between the proprietary wireless communication device 54 and the wireless sensors 24. The proprietary wireless communication device 54 may be configured to search for other remote sensor modules that meet an appropriate encryption signature of the proprietary wireless connection.

Additionally, the command module 20 may be configured to utilize sensor data from the end point sensors 22, 24 to allow the sensors 22, 24 to operate in unison with each other. Thus, the sensors 22, 24 may be able to provide other cumulative information from the combination of sensed signals (e.g., to determine the planarity of a long surface). The sensors 22, 24 may be configured as relays for relaying, such as in a daisy chain fashion, sensor signals from other sensors out of range of the proprietary wireless communication device 54 to allow sensing in less-accessible locations.

The command module 20 also allows for near field communication (NFC) at the specific unit being sensed. Local data can be retrieved from memory 58 or accessed through a cellular modem (e.g., proprietary wireless communication device 54) to retrieve archived cloud data.

A few examples of sensing environments of the remote diagnostic system 10 are described herein. One example may include a temperature control for sensing whether the temperature of a monitored area remains within predetermined thresholds. Another example may include a monitor, report, and service environment, where certain parameters of operating equipment are monitored for compliance with predetermined standards. Based on the results, the system may include reporting of the sensor data to an authorized person and/or opening a service call to correct any issues with the equipment.

In yet another example, a temperature monitoring system is envisioned where temperature in a particular space is monitored. Controls, alerts, etc. may be provided as a result of the measured temperature. Other examples may include vaccine and plasma storage, environmental chambers, autoclaves, ultra-low temperature freezers (e.g., −86° C., −122.8° F.), cryogenics (e.g., ≤−123° C., −191° F.), thermal shock chambers, growth chambers, etc.

Some examples may also include loss prevention devices. These examples may include freezers and ultra-low freezers, sample storage, cryo-storage, lab ovens/furnaces, autoclaves, growth chambers, focus on service, set-up, implementation, training, maintenance and control.

Data may be collected and collated from at least the following types of sensors: temperature (e.g., −200° C. to 1800° C.) sensors, electrical current (e.g., 0 to 20 A) sensors, digital sensors (e.g., a door-open condition), pressure sensors, CO₂ sensors, humidity sensors, remote switches, remotely active devices, mechanical gauge sensor Hall-effect transducers (e.g., used to read a mechanical gauge without any communication of information through the command module to the remote servers).

Other uses may include pressure vessels (e.g., propane tank) as well as any other mechanical gauge. In some embodiments, a sensor 22, 24 may be configured to read the rotational position of a metal gauge indicator (via Hall-effect transducers) and convert the information to an electrical signal without any physical contact (or disassembly) of the existing gauge.

Another example may include a current module (e.g., 4-20 mA). This may be a common signal to interface with existing industrial sensors. The data may be converted from the 4-20 mA current signal for wireless transmission.

Positional sensing may be another example. This type of sensing may assist with angle of loading, applicable in the field of heavy trucks and shipping to ensure optimal loading conditions. In this case, the sensors may work in unison to provide data regarding the relative position compared to each other. This may be useful in determining levelness or changes in position.

Regarding the sensor port 52 of the command module 20, the sensor port 52 allows for a high degree of remote flexibility on the type of data being sensed. The wireless end point sensors 24 may be powered by a standard battery with charger while also having a low voltage power input port. Each end point sensor 24 may also be configured to extend the proprietary communication range as they can be software configured to operate as a signal repeater.

The sensor ports 52 may include custom ports that can be used to accommodate a variety of sensing and/or computing “plug and play” sensor devices. These unique sensor ports 52 allow a variety of custom sensing solutions to be configured.

The ability of multiple endpoint sensors 22, 24 to work together allows the command module 20 to obtain positional data (e.g., levelness).

The processor 50 may be configured to log the sensor locally in memory 58 and/or remotely in database 36. The logged data may include a time stamp and GPS information to record the time the sensor data was obtained and the location of the sensor data when it was obtained.

Therefore, according to some embodiments, the present disclosure may be directed to the command module 20 of the remote diagnostic system 10, whereby the command module 20 may comprise at least one sensor port 52, where each sensor port 52 is configured for electrical connection with a sensor chip (e.g., sensors 22) that measures a parameter or condition. Each sensor port 52 is configured to receive sensor data obtained by the respective sensor chip. The command module 20 also includes a cellular communication device 56 configured to transmit the sensor data via the cellular network 14 to the backend cloud server 16 for diagnosing characteristics of the sensor data.

This command module 20 may further comprise the proprietary wireless communication device 54 configured to communicate wirelessly with at least one wireless sensor 24 that also measures a parameter or condition. In some embodiments, the command module 20 may further comprise the power source 60 for supplying power to the sensor chip.

Each sensor port 52 may comprise at least one ground pin, at least one power pin, at least one serial peripheral interface (SPI) pin, and at least one I²C pin.

The cellular communication device 56 in some embodiments may include a global positioning system (GPS) device 62 configured to determine the global position of the command module 20. The cellular communication device 56, when transmitting sensor data, may further be configured to transmit information about the global position along with the sensor data.

The command module 20 may be configured to handle site data processing and transmission through an integrated cellular modem/Ethernet or through Wi-Fi/Bluetooth devices to the remote cloud server. Additionally, the command module 20 has multi-use, custom sensor ports 52 that can accept multiple sensor types. The command module 20 contains a power supply 60 that can operate from a battery, DC voltage, or a solar charger. In addition to the direct measurement of data through the sensor ports 52, a proprietary, private wireless network is established and searches for other remote modules (e.g., wireless end point sensors 24 or other command modules 20) that meet the appropriate encryption signature.

By allowing modular sensors that plug into the sensor ports 52, the command module 20 can have an installation cost that is economically aligned to the number of points that need to be monitored. The command module 20 can also be reconfigured into an end point sensor if data needs exceed the capability of an end point sensor.

The command module 20 also allows for near field communication at the specific unit. Local data can be retrieved from the on-board memory 56 or accessed through the cellular modem to retrieve archived cloud data.

Examples of specific local networks 12 are described herein. In one example, backend diagnostic data may be tailored to refrigeration and temperature controlled products. The remote software (e.g., sensor data analysis program 40) may be configured to continuously analyze the sensor data to optimize maintenance schedules as well as to pinpoint component failures for more effective repair. Data may be used to create a remote diagnostic flowchart to isolate likely failure mechanisms. These diagnostic flowcharts may be stored in memory 38 and used for diagnostic programming applications.

FIG. 4 is a schematic diagram illustrating an embodiment of one or more of the sensor ports 52 shown in FIG. 3. In this embodiment, the sensor port 52 includes a pin layout having 12 connectors configured for connection with 12 pins of a corresponding sensor chip. Connectors 70, 76, 82, and 90 are ground connectors; connector 80 is a DC power connector; connectors 78 and 92 are CS connectors; connectors 84, 86, and 88 are SPI connectors; and connectors 72 and 74 are I2C connectors. In some embodiments, the sensor port 52 may have a spacing of 0.10 inches between connectors or pins and may have a width of 1.10 inches.

The sensor ports 52 may be used with appropriate data collection devices or sensors. Maximum flexibility has been designed into the physical system of the sensor ports 52. The connections include low voltage DC power, ground, SPI required signals, and I²C required signals. The CS signals (associated with the SPI communication) may be reconfigured via software to function as ADC input signals if needed.

Therefore, the remote diagnostic system 10 is presented. The architecture of the system 10 is designed such that multiple sensing solutions may be powered through a standard sensor port 52, such as the shown in the embodiment of FIG. 4. These sensor ports 52 may have a common physical and electrical connection, which allows multiple unique sensors 22, 24 to be connected.

The system 10 can then be expanded through the use of a low cost end point module which allows for one unique sensor, in addition to an onboard temperature and humidity measurement. The wireless end point sensors 24 communicate via a wireless protocol to the command module 20 which then collates the data and transmits it to the backend cloud server 16.

The sensor type may be configured remotely through the backend cloud server 16, thus allowing for any sensor to be placed in any position on the command module 20. The configuration of a single command module 20 plus remote end points allows for limitless modules to be configured and added to the network 10.

The end point sensors 24 are designed to communicate data wirelessly to the command module 20. Connection is made via a private wireless network including the proprietary wireless communication device 54 and the wireless sensors 24.

The command module 20 may be configured for onboard temperature and humidity measurement (onboard meaning, in one aspect, in a chip or circuit on the motherboard) in addition to a sensor port allowing a high degree of remote flexibility on the type of data measured. The endpoint sensors 22 are powered by a standard, rechargeable battery 60 while also having a low voltage power input port.

The sensor port for the endpoint sensor may be only one port or multiple ports and can include the daughter board that can be plugged into the control module (the control module being a system that the endpoint sensor communicates directly with to send data to the server). This is discussed in more depth later herein.

Each wireless end point sensor 24 may be designed to extend the proprietary wireless range as they can be software configured to operate as a signal repeater. The wireless end point sensors 24 allow for a more cost effective installation as they do not require wiring and are configurable to a variety of sensing options.

The sensor ports 52 are a proprietary design for use with the appropriate sensor data collection devices. Maximum flexibility has been designed into the physical system. The connection system may consist of the following signals: low voltage DC power, ground, SPI required signals, and I²C required signals. The CS signals (associated with the SPI communication) may be reconfigured via software to function as ADC input signals if needed. This configuration of sensor port allows for a high degree of flexibility so that cost effective measurement techniques can be accommodated.

A remote monitoring and backend diagnostic system is presented (System Diagram) with components as described below. The architecture of the system is designed such that multiple sensing solutions may be powered through a standard sensor port (Sensor Ports). These ports have a common physical and electrical connection. The sensor ports can then used in the command module, which allows multiple unique sensors to be connected (via the motherboard).

The system can then be expanded through the use of a low cost end point module which allows for one unique sensor that can be plugged into a slot on the endpoint sensor motherboard. The sensor may be provided in addition to the onboard parameter collection (e.g., temperature and humidity measurement) which is implemented in circuits/chips on the motherboard.

The endpoint sensors may communicate via a wireless protocol to the command module which then collates the data and transmits such data to a cloud server. The sensor type is configured remotely through the cloud server, thus allowing for any sensor to be placed in any position on the command module. The configuration of a single command module plus remote end points allows for limitless modules to be configured and added to the network.

A number of sensor examples are provided herein. The data may be collected and collated from the following sensors: Temperature: −200 C to 1800 C, Current/Voltage: 0 to 20 A or 24 VAC to 240 VAC, Digital Sensors: door open, for example, Ultrasonic or Laser Sensors: typically used to measure distance, Gas Sensors: used to measure carbon dioxide levels, carbon monoxide levels, and various other gases, Pressure, Remote Switch: remotely active devices, Hall Effect Transducers—used to read a mechanical gauge without any communicate the information through the command module to the remote servers (typical usage is found in pressure vessels (such as propane) as well as any other mechanical gauge); 4-20 mA Current modules: a common signal to interface with existing industrial sensors (the data is converted from the 4-20 mA signal for wireless transmission); and ADC modules: used with sensor types that vary voltage according to data measured.

The data is collected and send via cellular modem 56 to a backend system 16. The backend system 16 logs the data into a cloud server. Alarms can be configured for out of boundary conditions as well as various diagnostics. The backend system 16 monitors the equipment for conditions that are out of specification but also recognizes trends in data to facilitate maintenance or early identification of performance issues.

The backend system 16 also allows for the sensor to be configured remotely such that any sensor port can accommodate any sensor type. The backend system 16 also receives GPS data (from GPS 62) and can locate the devices (e.g., local networks 12) according to GPS coordinates.

A diagnostic application is presented that accesses the appropriate database and helps a technician or other user in the component diagnosis based on the archived data. Backend diagnostic data may be tailored to refrigeration and temperature controlled products. Data is collected and pulled from a cloud based server and used to create a remote diagnostic flowchart to isolate likely failure mechanisms (presented in diagnostic programming applications).

The system 10 includes custom ports used to accommodate a variety of sensing and/or computing devices. The system 10 also allows for remote configurability of sensors to provide maximum flexibility. Also, proprietary sensor ports may be used that allow any end point or command module to use the same sensors. Furthermore, the system 10 allows the ability to expand the system through the wireless endpoints and also remotely configure the sensors on endpoint sensors.

Although the local networks 12 may include any sensing environment, some particular examples are provided herein. For example, the sensing environment may include critical system monitoring to ensure that critical system are operating properly at all times. Another example is the monitoring of a medical cooler for transporting human organs, blood, etc. A further example includes the sensing of temperature in a refrigerated food transport vehicle. Other examples include monitoring the fuel level of gas/propane storage devices, monitoring level of stored grain or other foods, or monitoring other levels. Another example include monitoring levelness, potential sinking, potential over-turning, etc. of a load.

Command Module—Handles site data processing and transmission through an integrated cellular modem/ethernet or through wifi/blutooth devices to a remote cloud server. Additionally, the command module has multiuse, custom sensor ports that can accept multiple sensor types. The command module contains a power supply that can operate from a battery, DC voltage, or a solar charger. In addition to the direct measurement of data through the sensor ports, a proprietary, private wireless network is established and searches for other remote modules (end points or other command modules) that meet the appropriate encryption signature.

The command module may be a system which includes a single motherboard (or multiple motherboards) which includes multiples slots. Each of the slots are configured to receive a daughter board that measures a parameters (e.g., temperature, humidity, voltage, current, etc.) of an environment or a circuit. Thus, the command module can measure multiple parameters at the same time since multiple daughter boards can be plugged into the motherboard(s) of the command module. Moreover, the command module can communicate wirelessly with modular sensors (also referred to herein as “end point sensors”) which are also configured to measure and receive parameters at a certain location.

By allowing the modular sensors (that plug into the sensor ports) this allows the installation cost to be economically aligned to the number of points that need to be monitored. The command module can also be reconfigured into an endpoint sensor if data needs exceed the capability of an endpoint sensor.

The command module also allows for near field communication at the specific unit. Local data can be retrieved from the on-board memory or accessed through the cellular modem to retrieve archived cloud data.

End Point Sensors—The end point sensors are designed communicate data wirelessly to the command module via a connection which may be via the private wireless network. The end point sensors may have onboard temperature and humidity measurement circuits in addition to one or more sensor ports allowing a high degree of remote flexibility on the type of data measured. The sensor ports are slots in a motherboard of an endpoint sensor.

In one embodiment, each end point sensor (or at least one end point sensor) includes only one sensor port (e.g., slot on the end point sensor motherboard).

Each sensor port (whether only one or multiple ports) are configured to receive the same daughter board that can be plugged into the control module and vice versa. For example, if a temperature daughter board is plugged into the control module and a voltage daughter board is plugged into the only sensor port of an endpoint sensor, the voltage daughter board of the endpoint sensor can be removed from the endpoint sensor and plugged into the control module, and similarly, the temperature daughter board of the control module can be removed from the control module and then plugged into the single slot of the endpoint sensor. This provides maximum flexibility of the endpoint sensor which was not previously available since all current endpoint sensors do not have a motherboard with a single slot that can receive daughter boards that work in the control module. In this regard, the endpoint sensor can be a temperature sensor, voltage sensor, humidity sensor, etc. and need not be limited to a single type of sensor.

The endpoint sensors are powered by a standard, rechargeable battery while also having a low voltage power input port. Each endpoint sensor is designed to extend the proprietary wireless range as they can be software configured to operate as a signal repeater. The end point sensors allow for a more cost effective installation as they do not require wiring and are configurable to a variety of sensing options.

Sensor Ports—The sensor ports are a proprietary design for use with the appropriate sensor data collection devices. Maximum flexibility has been designed into the physical system as explained above.

The connection system is detailed below and may include the following signals: Low Voltage DC power, ground, SPI required signals and I2C required signals. The CS signals (associated with the SPI communication) may be reconfigured via software to function as ADC input signals if needed. This configuration of sensor port allows for a high degree of flexibility so that cost effective measurement techniques can be accommodated. For example, any board that can be plugged into the control module (which has a motherboard with multiple slots) can be removably plugged into the endpoint sensor.

Sensors/Remote Switches Examples

The data is collected and collated from the following sensors (using a daughter board): Temperature: −200 C to 1800 C, Current/Voltage: 0 to 20 A or 24 VAC to 240 VAC, Digital Sensors: Door open for example, Ultrasonic or Laser Sensors: Typically used to measure distance, Gas Sensors: Used to measure carbon dioxide levels, carbon monoxide levels and various other gases, Pressure, Remote Switch: Remotely actives devices, Hall Effect Transducers—these sensors are used to read a mechanical gauge without any communicate the information through the command module to the remote servers. Typical usage is found in pressure vessels (such as propane) as well as any other mechanical gauge.

4-20 mA Current modules: This is a common signal to interface with existing industrial sensors. The data is converted from the 4-20 mA signal for wireless transmission.

ADC modules: Used with sensor types that vary voltage according to data measured.

Each of these modules are implemented using separate daughter boards that can be plugged into a motherboard of the control module and in the endpoint sensor. In this regard, the endpoint sensor can be variable such that any daughter board which can measure a parameter can be included in the endpoint sensor and then switched with a daughter board that can measure a different parameter.

Backend System/Cloud Server

The data is collected and send via cellular modem to a backend system. The backend system logs the data into a cloud server. Alarms can be configured for out of boundary conditions as well as various diagnostics. The backend system monitors the equipment for conditions that are out of specification but also recognizes trends in data to facilitate maintenance or early identification of performance issues.

The backend system also allows for the sensor to be configured remotely such that any sensor port can accommodate any sensor type. The backend system also receives GPS data and can locate the devices according to GPS coordinates.

A diagnostic application is presented that accesses the appropriate database and helps a technician or other user in the component diagnosis based on the archived data.

In one embodiment, backend diagnostic data may be tailored to specific applications, such as refrigeration and temperature controlled products. Data is collected and pulled from a cloud based server and used to create a remote diagnostic flowchart to isolate likely failure mechanisms (presented in diagnostic programming applications).

In one embodiment, a custom port in the endpoint sensor is used to accommodate a variety of sensing and/or computing devices to provide flexibility in the endpoint sensor and the variety of sensing and/or computing devices can also be implemented in a control module (which the endpoint sensor communicates with).

The present applications provides remote configurability of sensors to provide maximum flexibility.

The present applications provides proprietary sensor ports that allow any end point or command module to use the same sensors.

The present applications provides the ability to expand the system through the wireless endpoints and also remotely configure the sensors on endpoint sensors.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a circuit, module, or system. Furthermore, aspects of the present invention may take the form of a computer program product embodied in one or more non-transitory computer readable medium(s) having computer readable program code embodied thereon.

Any combination of one or more non-transitory computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

All of the above description is some optimized implementation method and design choices. Therefore, the foregoing is considered as illustrative only of the principals of the invention. Further, since numerous modifications and changes will readily occur to those skilled in the art, it is not desired to limit the invention to the exact composition and use shown and described, and accordingly, all suitable modifications and equivalents may be restored to, falling within the scope of this invention.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

What is claimed is:

1. A remote diagnostic system comprising a backend cloud server configured to analyze at least one set of sensor data received from at least one remote system, the backend cloud server configured to receive the at least one set of sensor data via a cellular network.

2. The remote diagnostic system of claim 1, wherein the backend cloud server is configured to determine an alert condition when a first set of sensor data from a first remote system includes parameters outside an acceptable range.

3. The remote diagnostic system of claim 2, wherein the backend cloud server includes a controller for controlling the first remote system when the alert condition is determined.

4. The remote diagnostic system of claim 2, wherein the backend cloud server is configured to enable a remote access terminal to access sensor data related to one of the at least one remote system.

5. The remote diagnostic system of claim 1, wherein each remote system comprises a command module and one or more end point sensors for obtaining a set of sensor data.

6. The remote diagnostic system of claim 5, wherein the command module is configured to transmit the set of sensor data via the cellular network to the backend cloud server.

7. The remote diagnostic system of claim 5, wherein at least one of the one or more end point sensors includes a chip configuration for connection to a sensor port of the command module.

8. A command module of a remote diagnostic system, the command module comprising:
at least one sensor port, each sensor port configured for electrical connection with a sensor chip that measures a parameter or condition, and each sensor port configured to receive sensor data obtained by the respective sensor chip; and
a cellular communication device configured to transmit the sensor data via a cellular network to a backend cloud server for diagnosing characteristics of the sensor data.

9. The command module of claim 8, further comprising a proprietary wireless communication device configured to communicate wirelessly with at least one wireless sensor that measures a parameter or condition.

10. The command module of claim 8, further comprising a power source for supplying power to the sensor chip.

11. The command module of claim 8, wherein each sensor port comprises at least one ground pin, at least one power pin, at least one serial peripheral interface (SPI) pin, and at least one I²C pin.

12. The command module of claim 8, wherein the cellular communication device includes a global positioning system (GPS) device configured to determine the global position of the command module.

13. The command module of claim 12, wherein the cellular communication device is further configured to transmit information of the global position along with the sensor data.
